(19) United States
(12) Patent Application Publication
(10) Pub. No.: US 2016/0336109 A1
(43) Pub. Date: Nov. 17, 2016

(54) TRANSFORMER WITH IMPROVED HEAT DISSIPATION

(71) Applicant: TRITIUM HOLDINGS PTY LTD, St Lucia (AU)

(72) Inventors: David Andrew Finn, Holland Park, QLD (AU); Alexander Kris Rudzki, Bardon (AU); James McFarlane Kennedy, St. Lucia (AU)

(21) Appl. No.: 15/112,629

(22) PCT Filed: Jan. 20, 2015
(86) PCT No.: PCT/AU2015/000024

§ 371 Date: Jul. 19, 2016

(30) Foreign Application Priority Data
Jan. 20, 2014 (AU) 2014900159

(51) Int. Cl. H01F 27/28; H01F 41/063; H01F 41/066; H01F 27/32

(52) U.S. Cl. CPC H01F 27/2876; H01F 27/325; H01F 41/063; H01F 41/066

(57) ABSTRACT

A transformer assembly (2) includes a base (4) comprising a CNC machine milled aluminum plate that is designed for liquid cooling. Three magnetic flux conductive cores (30a, 30b, 30c) are mounted to the core and are interlinked by three winding assemblies (6a, 6b and 6c). The winding assemblies each include a plurality of heat conductive members (10). The heat conductive members (10) extend from the base through the winding assemblies and conduct operative heat from the winding assemblies to the base for dissipation from the base during use. The heat conductive members each comprise a copper tube sealed at either end with a fluid within. In use a convection current forms in the fluid that causes the fluid to circulate from one end of the tube to the other thereby transmitting heat along the conductive member to thereby transmit heat from the coils to the liquid cooled base in use.

### TECHNICAL FIELD

The present invention relates to electrical transformers and more particularly to compact transformers designed to dissipate operating heat.

### BACKGROUND

Any references to methods, apparatus or documents of the prior art are not to be taken as constituting any evidence or admission that they formed, or form part of the common general knowledge.

Electrical transformers provide magnetic circuits to couple an input alternating electrical current to an output alternating electrical current whilst presenting an open circuit to direct current signals. Consequently one application for transformers, apart from voltage conversion, is that of providing DC isolation.

Where high frequency alternating currents are applied to a transformer the amount of heat dissipated by the transformer may be problematic. For example, it may be necessary to incorporate the transformer into a dense circuit assembly. The heat dissipated by the transformer may be detrimental to the operation of other electrical and electronic components of the assembly. Furthermore, the operating efficiency of the transformer falls off if the heat generated during its operation is not rapidly dissipated.

Various approaches have been made in the past to cooling transformers. One approach is to immerse the transformer in a large body of transformer oil. Another approach is to bolt the transformer to a chassis that includes air fins and to then force air over the fins to thereby cool them.

It is an object of the present invention to provide a transformer with improved heat dissipation properties which addresses the above described problems of the prior art or which is at least a commercial alternative to other solutions which have hitherto been provided to address the problems of the prior art.

### SUMMARY OF THE INVENTION

According to a first aspect of the present invention there is provided a transformer assembly including:
a heat dissipating base;
one or more transformer winding assemblies having a plurality of heat conductive members;
wherein the heat conductive members extend from the base to thereby conduct operative heat from the one or more winding assemblies to the base for dissipation of the heat therefrom.

Preferably the base is formed with at least one conduit therethrough for passing a coolant such as a cooling fluid, for example water.

In an alternative embodiment of the invention the base may be provided with fins for air cooling.

It is preferred that the base is formed with one or more indentations that receive portions of one or more transformer cores for the winding assemblies.

The base may be formed with indentations which locate transformer core portions interlinking the winding assemblies.

In a preferred embodiment of the invention the transformer assembly includes a thermally conductive and electrically insulating compound that seals the winding assemblies and the heat conductive members.

For example the compound may comprise an epoxy compound.

Preferably the transformer assembly includes a mould that rises about a periphery of the base for containing the compound as it sets during manufacture.

For example the base may include formations that support the mould.

It is preferred that the one or more transformer winding assemblies each comprise insulated wire wound about a bobbin. Alternatively the transformer winding assemblies may be bobbin-less in which case the wire of the windings is sufficiently rigid for the winding assembly to retain its shape.

In a preferred embodiment of the invention the transformer assembly is arranged for multi-phase, for example three-phase, operation wherein the one or more transformer winding assemblies comprise three winding assemblies each corresponding to one of said phases.

Alternatively the transformer may be arranged for single-phase operation wherein the one or more transformer winding assemblies comprise a single winding assembly.

Preferably at least one of the transformer winding assemblies includes a temperature sensor for monitoring operating temperature during use. For example, the temperature sensor may comprise a thermistor.

It is advantageous that the transformer layout be compact. For example, where the transformer assembly is arranged for three phase operation the winding assemblies and core portions may be laid out along the sides of an equilateral triangle.

According to a further aspect of the present invention there is provided a method for the production of a heat dissipating transformer assembly comprising the steps of:
winding wire about one or more heat conductive members and forming one or more winding assemblies;
providing a heat dissipating base;
locating one or more transformer cores upon the base;
arranging the one or more winding assemblies relative to the one or more transformer cores wherein ends of the heat conductive members are coupled to the base.

The base may be formed with receptacles that receive respective ends of the head conductive members to thereby couple them to the base. Alternatively, the ends of the heat conductive members may be coupled to the base with a heat conductive compound such as a thermal paste.

Where the transformer is of a multiphase type the step of arranging the winding assemblies includes placing the one or more winding assemblies to interlink the transformer cores.

Preferably the method includes inserting one or more heat sensors into the transformer winding assemblies during the winding of the wire.

Preferably the method includes setting a heat conductive and electrically insulating compound about at least the transformer winding assemblies.

The method may include forming a mould for such compound about the winding assemblies. The step of forming a mould for the compound may include locating walls of the mould in engagement formations, for example a recess, formed in the base.

Preferably the method includes degassing the compound prior to it setting. For example the method may include applying a vacuum to the compound.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 depicts a transformer assembly according to a preferred embodiment of the invention prior to application of a potting compound.

FIG. 2 is a plan view of an underside of a heat dissipating base of the assembly of FIG. 1.

FIG. 3 is a plan view of the topside of the base of FIG. 2.

FIG. 4 shows the base of FIGS. 2 and 3 with bottom halves of transformer cores located thereon.

FIG. 5 shows a bobbin of a winding assembly of the transformer assembly of FIG. 1.

FIG. 6 shows a primary coil of the one of the winding assemblies.

FIG. 7 shows the winding assembly during a further stage of production.

FIG. 8 shows a heat sensor of the winding assembly.

FIG. 9 shows a finished winding assembly.

FIG. 10 shows the transformer assembly during an early stage of production wherein one winding assembly has been fitted.

FIG. 11 shows the transformer assembly during a subsequent stage of production wherein two winding assemblies have been fitted.

FIG. 12 shows the transformer assembly during a further stage of production wherein three winding assemblies have been fitted.

FIG. 13 shows the transformer assembly during another stage of production wherein a mould has been erected about the transformer windings.

FIG. 14 shows the transformer assembly during another stage of production wherein a top plate has been fastened over the mould prior to introduction of a potting compound.

FIG. 15 shows the final transformer assembly with potting compound according to a preferred embodiment of the present invention.

FIG. 16 is a plan view of the transformer assembly showing it in use with coolant being circulated through its baseplate.

FIG. 17 is an isometric view of a single phase transformer according to a further embodiment of the present invention.

FIG. 18 is a side view of the transformer of FIG. 17.

FIG. 18A is an exploded view of the transformer of FIG. 17.

FIG. 19 is a top view of the transformer of FIG. 17.

FIG. 20 is a front view of the transformer of FIG. 17.

FIG. 21 is a front view of a single phase transformer with fluid cooled baseplate according to a further embodiment of the present invention.

FIG. 22 is a front view of a single phase transformer with a baseplate that bears air cooling fins.

### DETAILED DESCRIPTION OF PREFERRED EMBODIMENTS

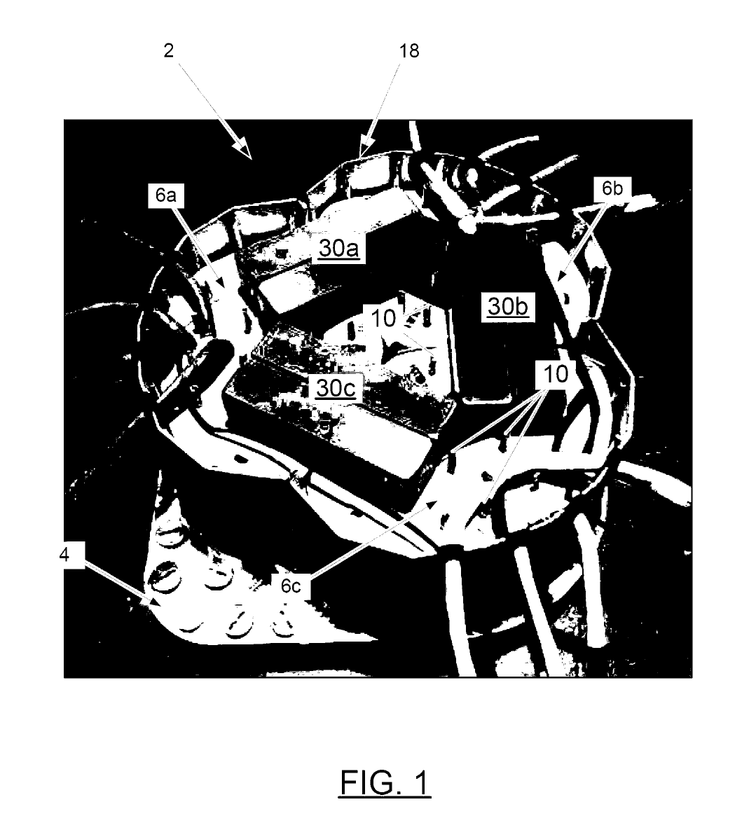

Referring now to FIG. 1, there is depicted a transformer assembly 2 according to a preferred embodiment of the present invention. Transformer assembly 2 includes a base 4, or as it may variously be called herein a “baseplate”, which in the presently described exemplary embodiment comprises a CNC machine milled aluminum plate that is designed for liquid cooling. Three magnetic flux conductive cores 30a, 30b, 30c are mounted to the core and are interlinked by three winding assemblies 6a, 6b and 6c.

As will be explained in more detail, the winding assemblies each include a plurality of heat conductive members 10. The heat conductive members 10 extend from the base 4 through the winding assemblies and conduct operative heat from the winding assemblies 6a, 6b, 6c to the base 4 for dissipation therefrom during use. The heat conductive members 10 are commercially available items that comprise a copper tube sealed at either end with a fluid within. In use a convection current forms in the fluid that causes the fluid to circulate from one end of the tube to the other thereby transmitting heat along the conductive member. One supplier of such heat conductive members is Element 14 of 72 Ferndell Street, Chester Hill, NSW 2162, Australia. The preferred conductive member is Element 14 part number CCI-00C93390101-HEAT PIPE, 100 MM, 5 MM DIA manufactured by Chaun-Choung Technology Corp. 12F., No. 123-1, Xingde Rd., Sanchong Dist., New Taipei City 241, Taiwan (R.O.C.), http://www.ccic.com.tw.

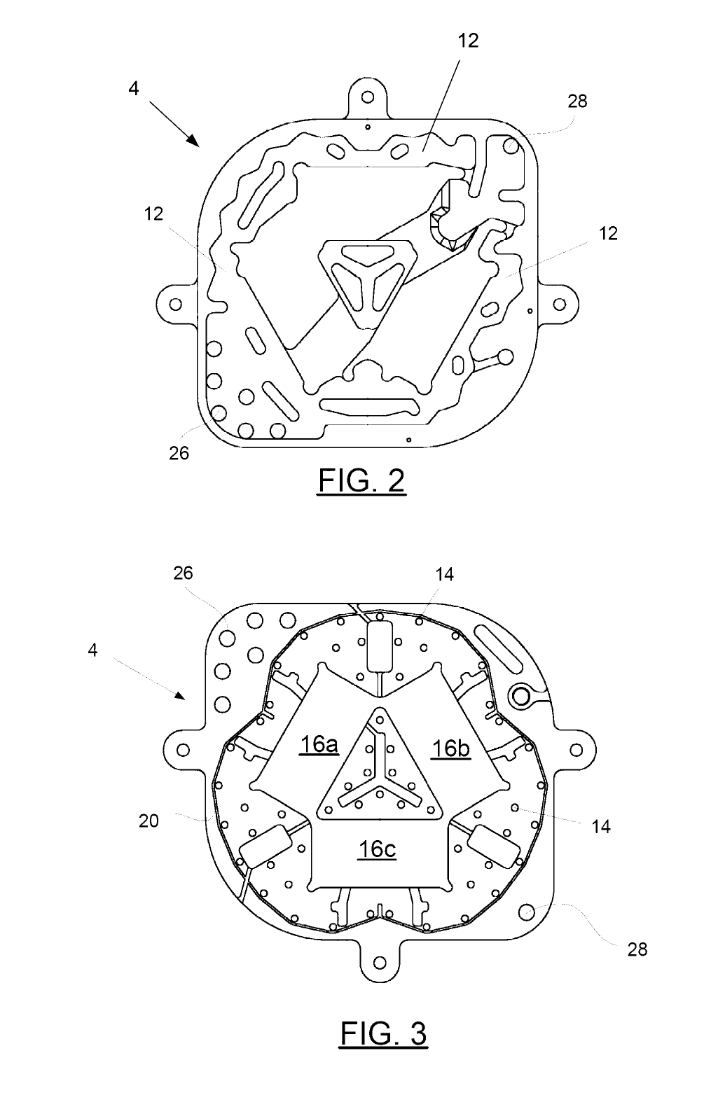

Referring now to FIG. 2, there is shown the underside of the base 4. The base is formed with conduits in the form of channels 12 for passing a cooling fluid between ports 28 and 26. For example the cooling fluid will most usually be water that is passed through the channels 12 in order to cool the base to thereby dissipate the heat that is transferred thereto from the winding assemblies via the heat conductive members 10.

FIG. 3 is a top plan view of the heat dissipating base 4. It is formed with indentations 16a, 16b and 16c which respectively locate lower portions of cores 30a, 30b, 30c. It is includes a formation comprising a peripheral recess 20 which receives a lower border of the mould 18 (shown in FIG. 1). The top side of the base 4 bears a plurality of receptacles in the form of sockets 14 which receive ends of the heat conductive members 10.

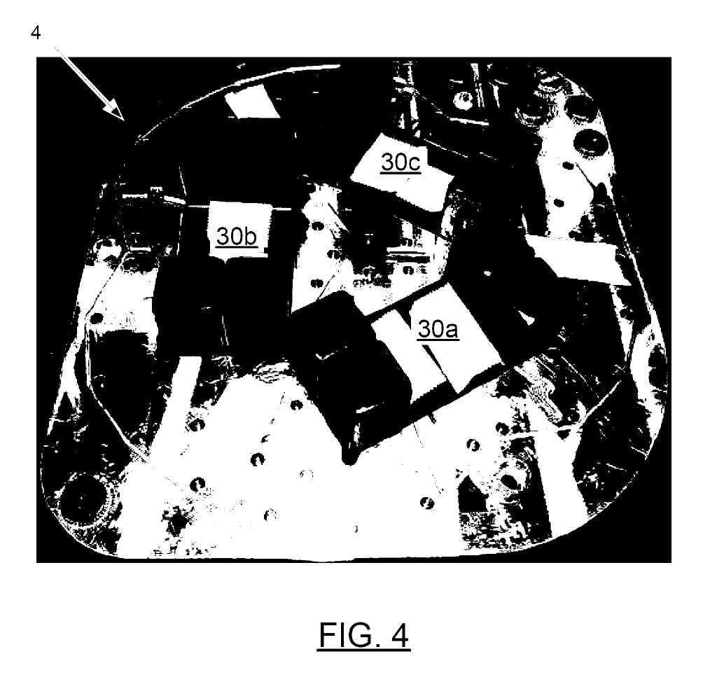

Referring now to FIG. 4, lower halves of the cores 30a to 30c can be seen located in the corresponding indentations 16a, 16b, 16c of the base 4. It will be realized that by forming the indentations in the base the cores 30a to 30c are rapidly and accurately positioned in their correct place, which while not essential is desirable. Furthermore, because they are snugly received into the indentations of the base there is a degree of heat transfer from the cores to the base which assists in drawing heat away from the winding assemblies 6a to 6c.

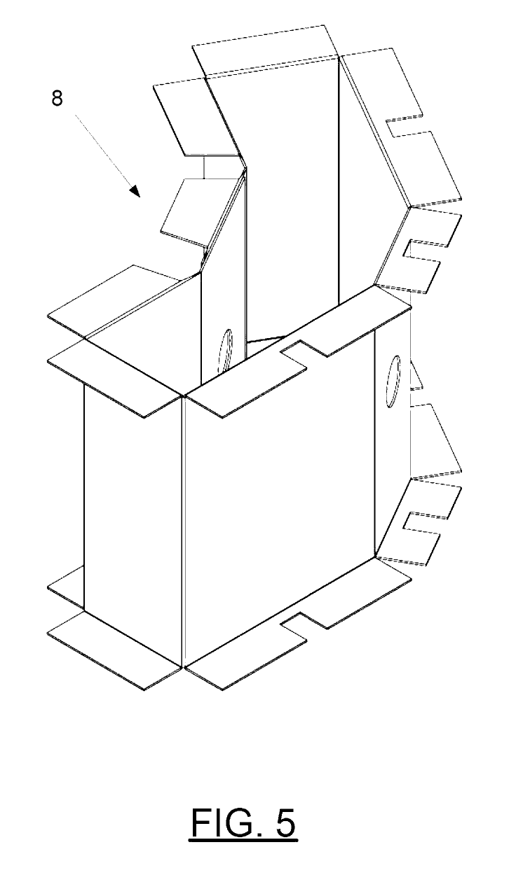

FIG. 5 depicts a bobbin 8, being a former upon which coils are wound during formation of the winding assemblies 6a to 6c (generally referred to as item “6” in the following).

A bobbin is preferably, though not necessarily used to assist in forming a fixed shape for the coils. In some embodiments of the invention the wire will be of a type that will hold its shape without need for a bobbin. Alternatively, in some embodiments the transformer cores may suffice for the wire to be wound thereabout without requiring the use of a bobbin.

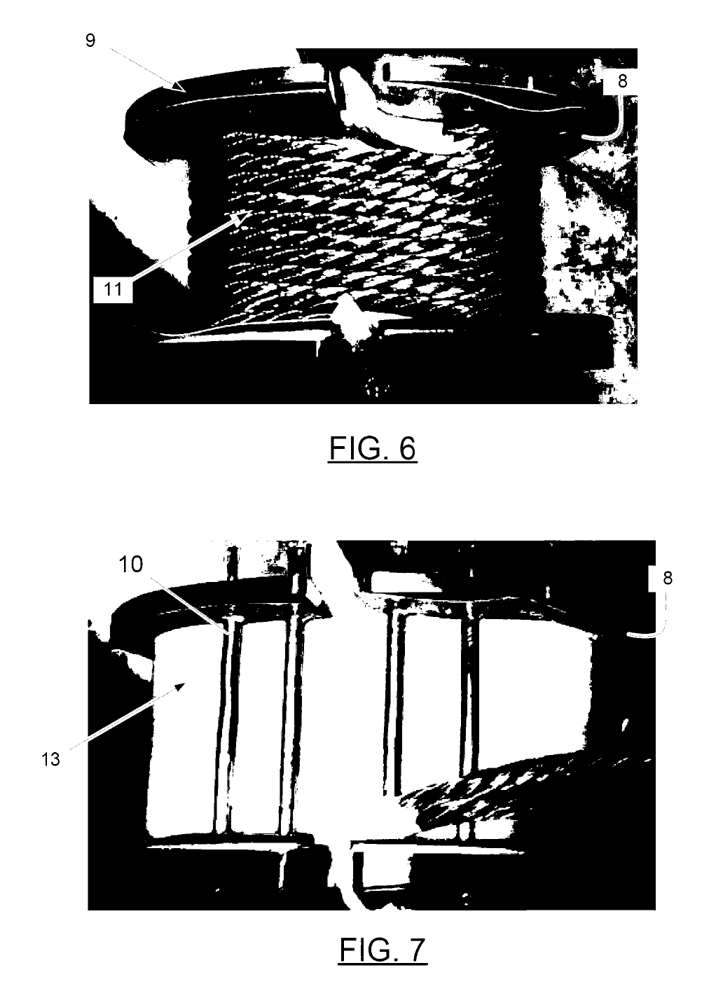

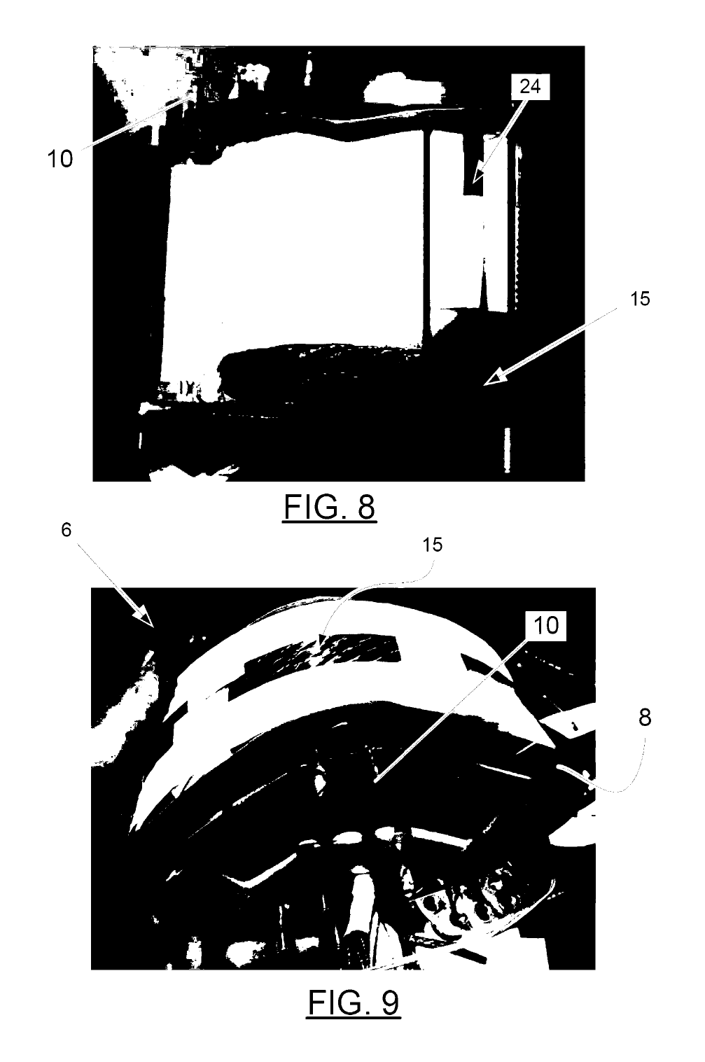

Referring now to FIG. 6, during production, according to a preferred and exemplary method, the bobbin 8 is held in a winding jig 9 and a primary coil 11 of wire is wound onto the bobbin. Once the primary coil 11 has been wound it is covered with transformer tape 13 as shown in FIG. 7. Heat conductive members 10 are then inserted through the upper and lower flanges of the bobbin 8 and against the transformer tape 13. As shown in FIG. 8, a heat sensor 24 in the form of a thermistor is also mounted against the transformer tape 13 for monitoring the operating temperature of the winding assembly 6 in use.

Once the heat conductive tubes 10 and the heat sensor 24 have been installed the secondary coil 15 is wound onto the bobbin 8 about the primary coil 11. FIG. 9 shows the final winding assembly 6.

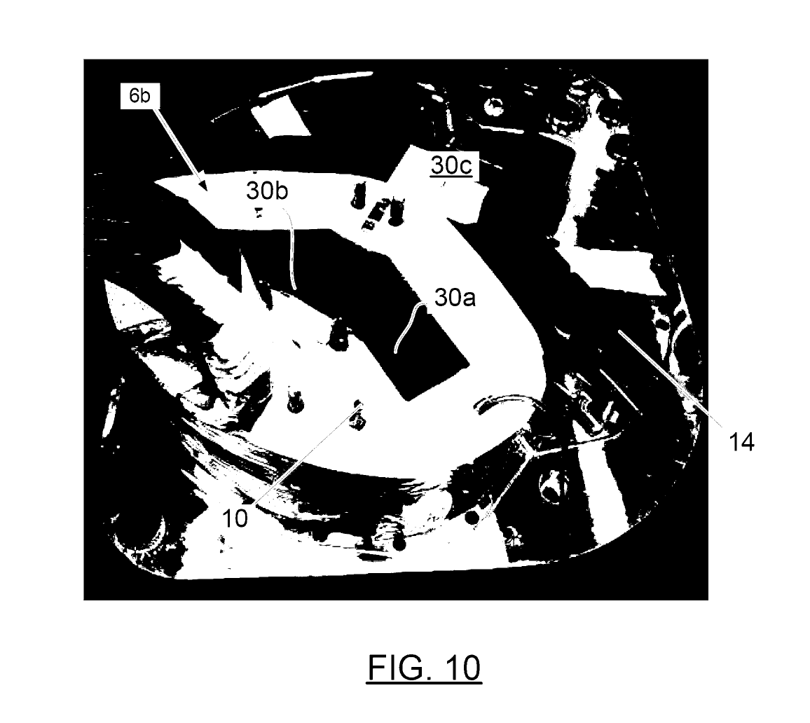

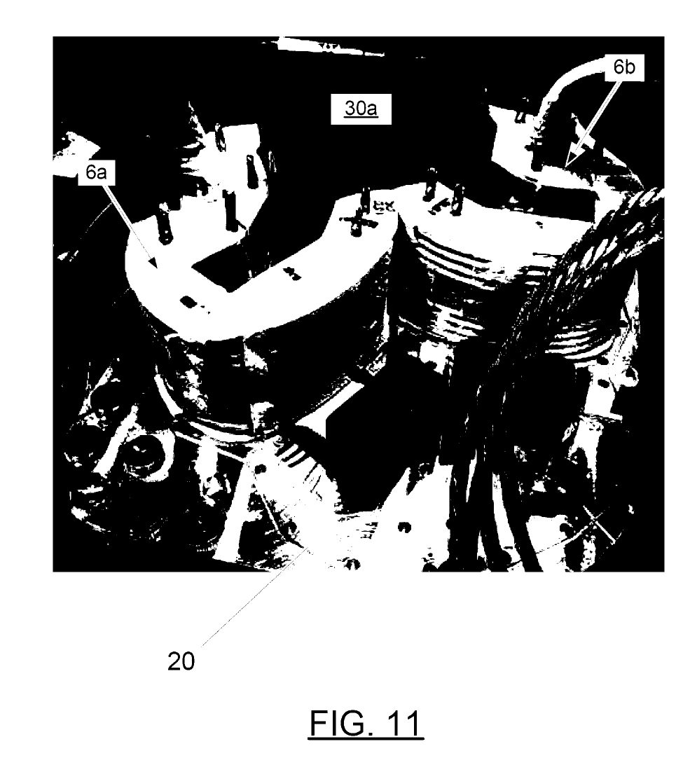

Referring now to FIG. 10, winding assembly 6b has been located over the adjacent ends of the lower halves of cores 30b and 30a. It will be noted that the lumen of the bobbin 8 is shaped so as to complement the shape of the adjacent ends of the lower halves of the cores. As the winding assembly 6a is put into place the bottom ends of its heat tubes 10 locate into the sockets 14 that are formed in the base 4.

FIG. 11 shows a further stage in the production of the transformer assembly wherein the winding assembly 6b has been placed in position and the top half of the core 30a has been inserted over its bottom half.

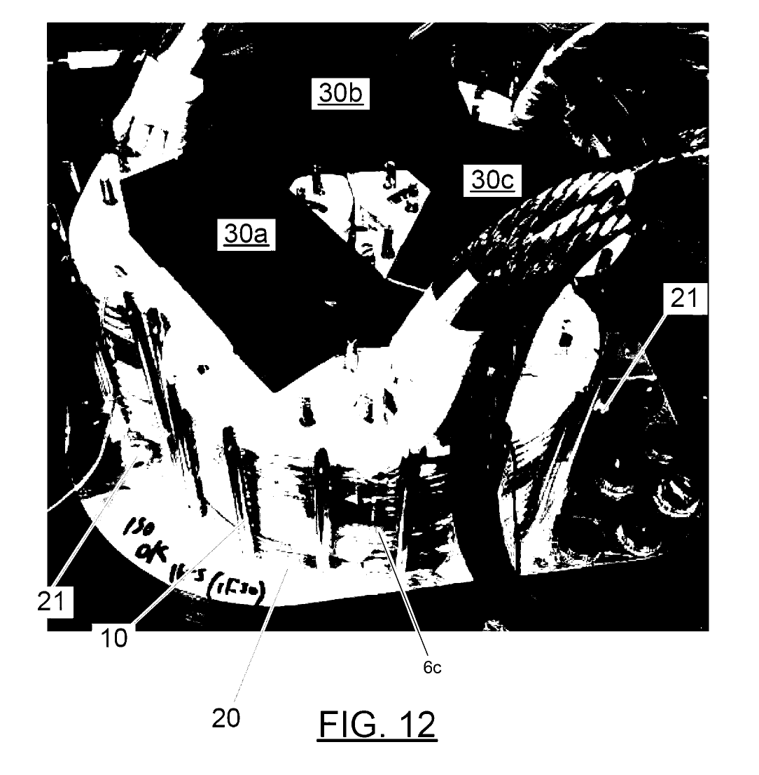

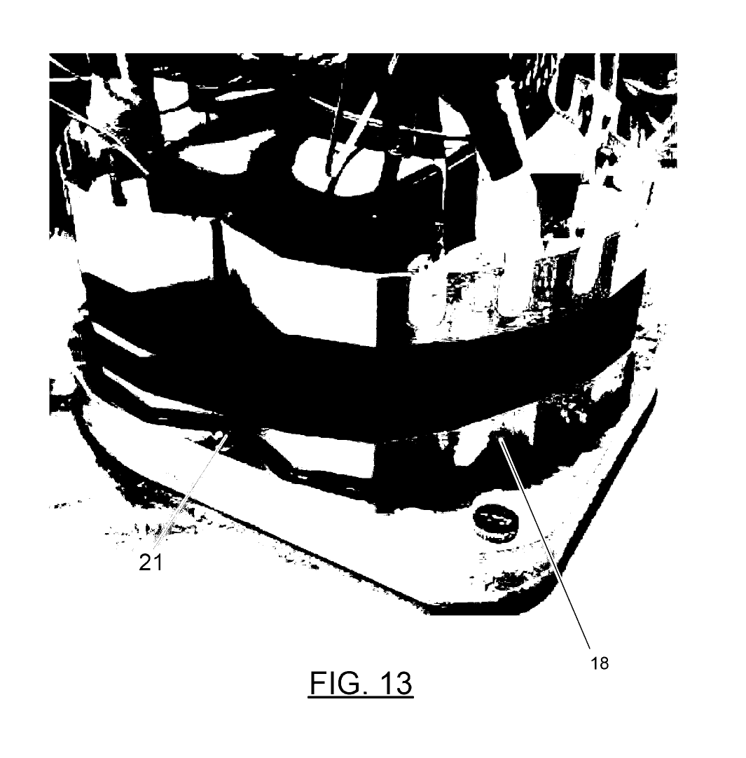

FIG. 12 shows the next stage wherein winding assembly 6c has been located in position and the top halves of the cores 30b and 30c have also been put in place. It will be noted that heat conductive tubes 10 have now been placed around the outside of the winding assemblies 6a, 6b, 6c with their bottom ends received into sockets 14 formed into the base 4 on the inside of the peripheral recess 20 of base 4. Referring now to FIG. 13, the mould 18, which is comprised of three separate arcuate segments that are fastened to each other with sealant and held in place with tape, is positioned in the peripheral recess 20 and sealant is applied about its base.

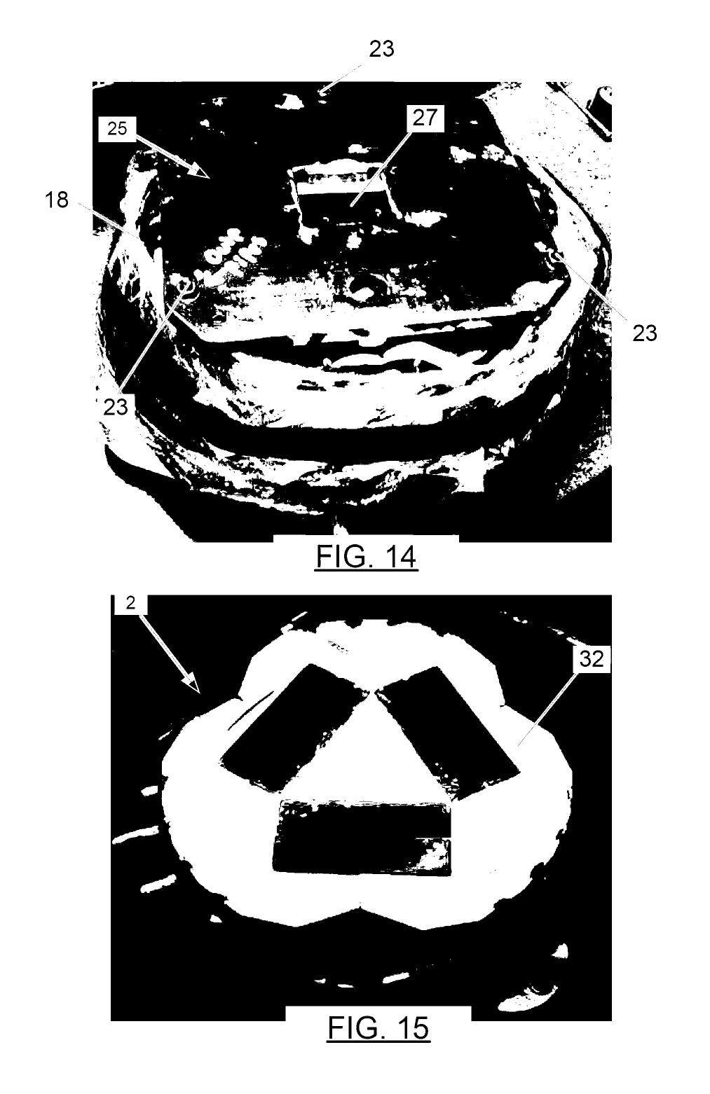

Referring now to FIG. 14, a plate 25 is fastened over the top of the mould 18. The plate is fastened by means of long bolts 23 that are received into threaded holes 21 (visible in FIGS. 11 and 12) of the base 4. A thermally conductive and electrically insulating compound 32, e.g. epoxy resin is then poured through the aperture 27 of the plate 25. The compound 32 seals the winding assemblies and the heat conductive members. The transformer assembly with plate 25 and potting compound 32 is placed in a degassing vacuum at a pressure of 29 inches of mercury for at least one hour. It is then baked in a 60 C oven for a minimum of four hours. It will be realized that the pressure, baking temperature and baking time are merely preferred examples. The resulting transformer assembly with hardened compound 32 is shown in FIG. 15. While not essential, the compound assists in heat transfer to the base 4 and also in preventing noise due to oscillation of the winding assemblies (i.e. “transformer hum”) during use.

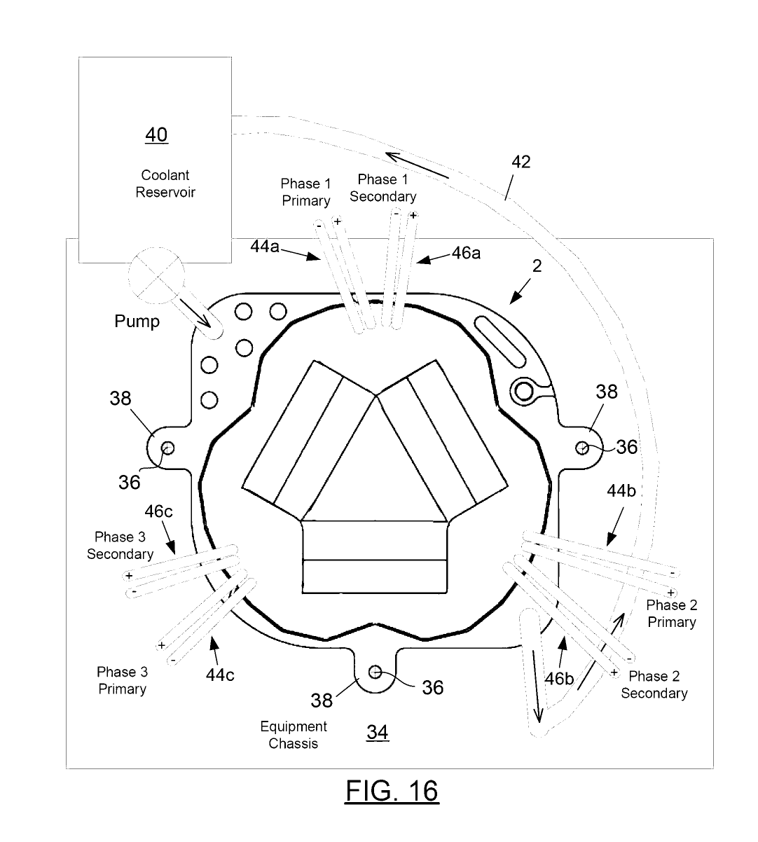

FIG. 16 shows the transformer assembly 2 in use. It is fastened with screws 36, which penetrate through holes formed in lugs 38 that extend from the base 4, onto the overall electronics enclosure or equipment chassis 34. Coolant, such as water is pumped through the conduits in the base to a reservoir 40 and recirculated via pipe 42 in order to cool the base. The primary 44a, 44b, 44c and secondary 46a, 46b, 46c coil terminals of each phase, i.e. of each of the winding assemblies, are coupled to electronic circuitry, e.g. loads and power sources, as required in each particular application. The application of power to the winding assemblies causes heat to be generated in the winding assemblies and the cores. Heat is transferred, by means of the heat conductive members 10 to the base which is able to dissipate the heat.

The transformer assembly that is the subject of the previously described exemplary embodiment has a weight of 18 kg and a power handling capability of 50 kW. It has an input to output voltage ratio of 1:1 and operates at 10 kHz. The heat dissipation at the maximum load is approximately 500 Watts. The wire used in each of the winding assemblies is Litz wire however a flat copper foil winding or other suitable electrical conductor might also be used. It will however be realized that the above specifications are provided merely for understanding of the preferred embodiment and do not limit the invention that is claimed.

Although the present invention has been described with reference to a three phase transformer in other embodiments a single (or other number of phases) transformer assembly might be produced in accordance with the invention.

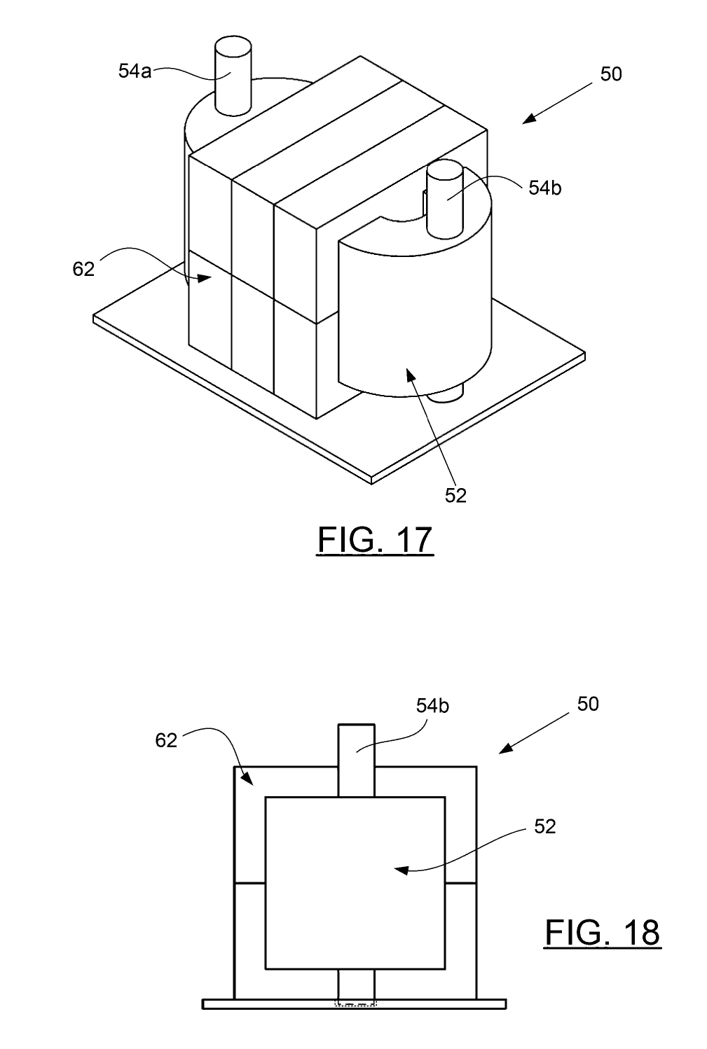

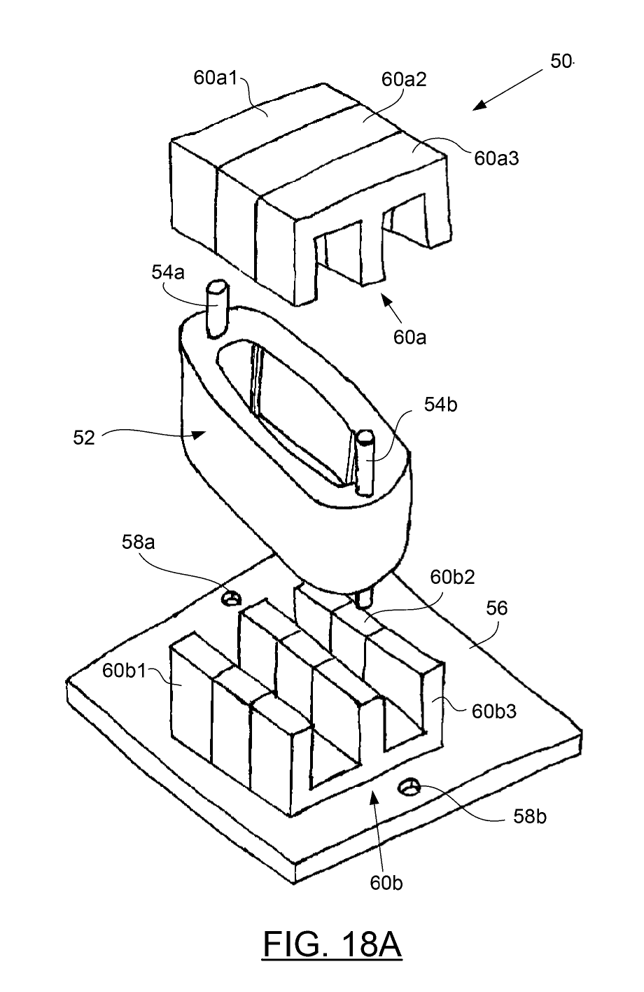

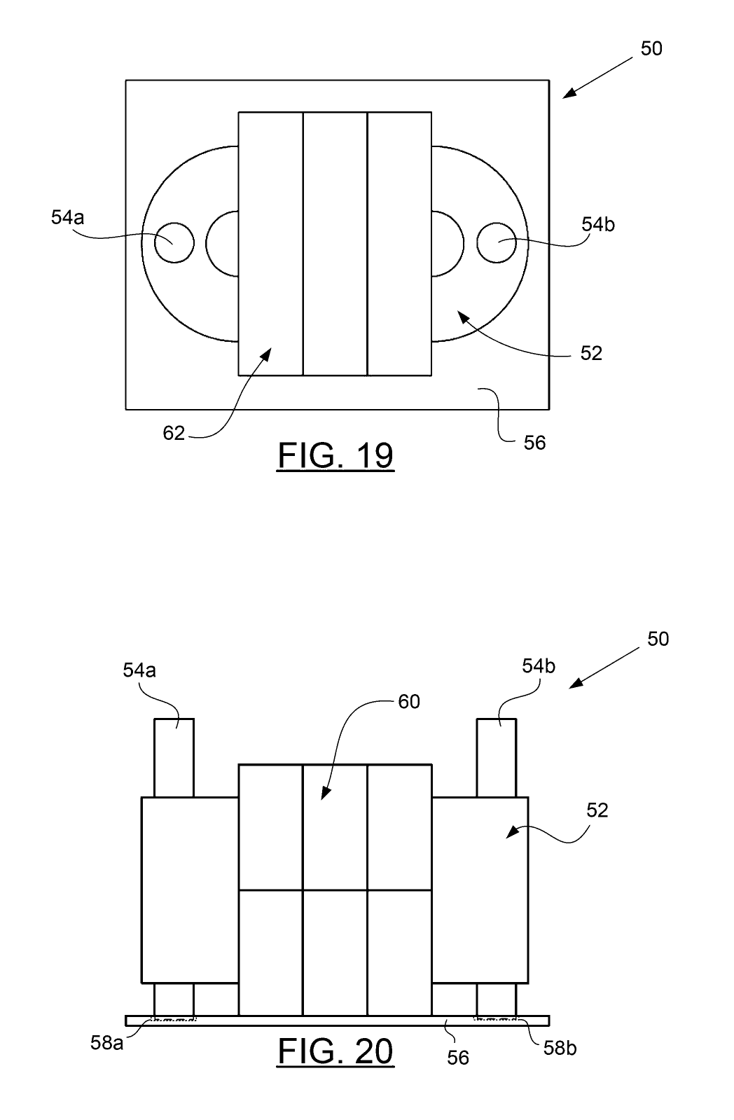

FIGS. 17 to 20 are respectively isometric, side, top and front views of a single phase transformer assembly 50 according to a further embodiment of the present invention. FIG. 18A is an exploded view of the transformer assembly of FIG. 17. The transformer assembly 50 is comprised of a winding assembly 52 which includes two, or more, magnetically coupled windings. The winding assembly 52 may be wound on a bobbin or alternatively simply formed in the shape shown of the winding assembly 52.

Heat conductive members 54a, 54b, which are of the same type as item 10 of the embodiment of FIG. 1, are interspersed between the windings of the winding assembly 52 and assist in transferring heat from the winding assembly 52 to a base in the form of baseplate 56. The baseplate 56 is made of aluminum or some other material with suitably high heat conductive properties. In the presently described embodiment the base, i.e. baseplate 56, is formed with receptacles in the form of sockets being blind bores 58a, 58b which respectively snugly receive the lower ends of the heat conductive members 54a, 54b. Alternatively the baseplate may not be formed with the bores in which case the lower ends of the heat conductive members could simply abut the baseplate though in that case the heat transfer may be reduced. A thermally conductive compound such as heat conductive paste may be used to assist in coupling the heat conductive members to the baseplate.

As best seen in FIG. 18A, the coil assembly 52 is located between the two halves 60a, 60b of transformer core 62. Each core half, 60a, 60b is comprised of three parallel segments 60a1, 60a2, 60a3 and 60b1, 60b2, 60b3. The entire transformer may be potted or varnished to reduce vibration in use and to add structural integrity.

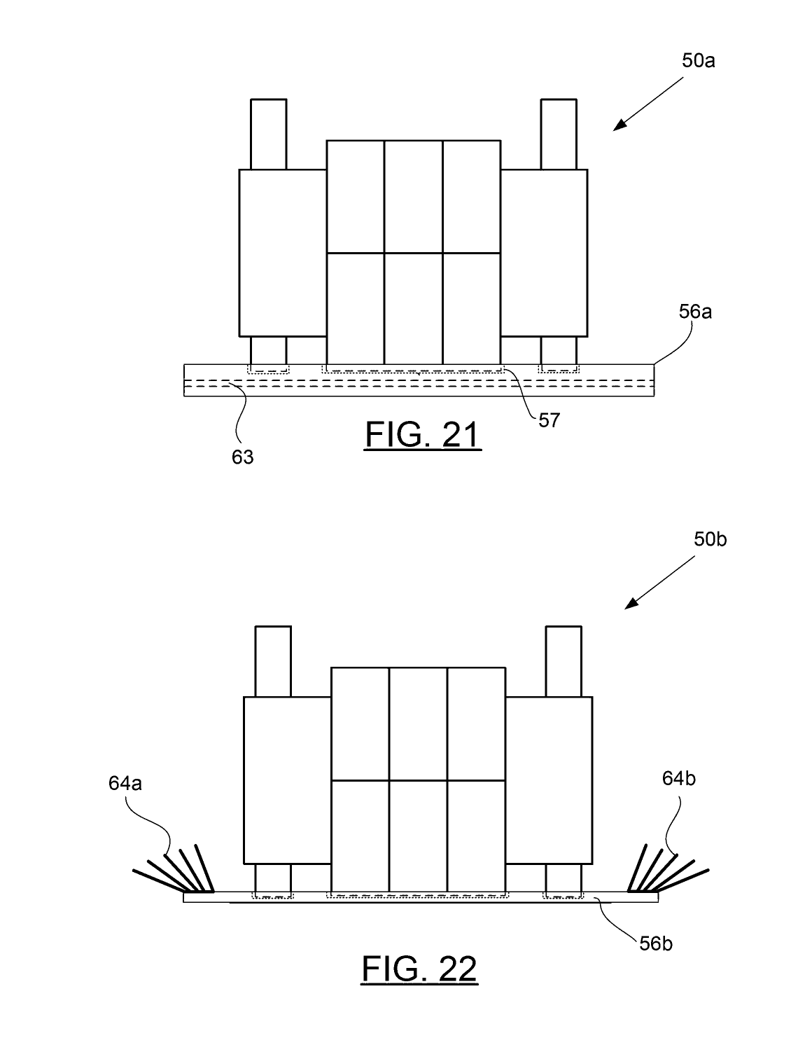

Referring now to FIG. 21, there is depicted a further embodiment of the invention in the form of a single phase transformer 50a, which is the same as the previously described transformer 50 except that baseplate 56a is formed with a conduit 63 therethrough through which a cooling fluid, for example water, may be pumped to assist in cooling the baseplate. In this embodiment the baseplate 56a is formed with an indentation 57 which corresponds to, and receives, a lower portion of the transformer core 62.

Another embodiment of the invention in the form of a single phase transformer 50b is depicted in FIG. 22. The baseplate 56b of the transformer of FIG. 22 is provided with fins 64a, 64b to assist with air cooling of the baseplate 56b.

The transformer assemblies of FIGS. 17 to 22 are manufactured in a similar way to that of FIGS. 1 to 16, for example, preferably:
1. Wire is wound around a bobbin or, where the wire is suitable for a bobbin-less construction, formed into a suitable shape.
2. Heat conductive members are interspersed within the wire winding.
3. Transformer cores are positioned within the wire shape (with or without a bobbin).
4. The wound cores are mounted to a baseplate which the heat members are coupled into, by inserting the ends of the heat members into formations formed with the baseplate such as bores and/or with the use of heat conductive compound.
5. The resulting structure may then be potted or varnished to assist in maintain its shape and reducing vibration during operation.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

Any embodiment of the invention is meant to be illustrative only and is not meant to be limiting to the invention. Therefore, it should be appreciated that various other changes and modifications can be made to any embodiment described without departing from the spirit and scope of the invention.

1. A transformer assembly including:
a heat dissipating base;
one or more transformer winding assemblies having a plurality of heat conductive members, the heat conductive members being elongate and including portions disposed between adjacent windings of the one or more winding assemblies;
wherein the heat conductive members extend from the base to thereby conduct operative heat from the one or more winding assemblies to the base for dissipation of the heat therefrom.

2. A transformer assembly according to claim 1, wherein the base is formed with at least one conduit therethrough for passing a cooling fluid.

3. A transformer assembly according to claim 1, wherein the base is formed with a plurality of receptacles for receiving respective ends of the plurality of heat conductive members.

4. A transformer assembly according to claim 1, wherein the base is formed with one or more indentations that receive portions of one or more transformer cores for the winding assemblies.

5. A transformer assembly according to claim 1 arranged for three-phase operation wherein the one or more transformer winding assemblies comprise three winding assemblies each corresponding to one phase of the three-phase operation.

6. A transformer assembly according to claim 5, wherein the winding assemblies and core portions are laid out along the sides of an equilateral triangle.

7. A transformer assembly according to claim 1, arranged for single-phase operation wherein the one or more transformer winding assemblies comprise a single winding assembly.

8. A transformer assembly according to claim 1, wherein at least one of the one or more transformer winding assemblies includes a temperature sensor for monitoring the temperature of the winding assemblies during use.

9. A transformer assembly according to claim 1, wherein the transformer assembly includes a thermally conductive and electrically insulating compound that seals the winding assemblies and the heat conductive members.

10. A transformer assembly according to claim 9, including a mould that rises from the base for containing said compound as it sets during manufacture.

11. A transformer assembly according to claim 10, wherein the base includes formations that support the mould.

12. A transformer assembly according to claim 1, wherein the one or more transformer winding assemblies comprise insulated wire wound about a bobbin.

13. A transformer assembly according to claim 1, wherein the one or more transformer winding assemblies are bobbin-less.

14. A method for the production of a heat dissipating transformer assembly comprising the steps of:
winding wire about a plurality of elongate heat conductive members and forming one or more winding assemblies wherein portions of the heat conductive members are interspersed between windings of the one or more winding assemblies;
providing a heat dissipating base;
locating one or more transformer cores upon the base;
arranging the one or more winding assemblies relative to the one or more transformer cores wherein ends of the heat conductive members are coupled to the base.

15. A method according to claim 14, wherein the base is formed with receptacles that receive respective ends of the heat conductive members.

16. A method according to claim 14, wherein the step of arranging the transformer windings includes placing the one or more transformer winding assemblies to interlink the transformer cores to thereby produce a multi-phase transformer assembly.

17. A method according to claim 14, including inserting one or more heat sensors into the transformer winding assemblies during the winding of the wire.

18. A method according to claim 14, including setting a heat conductive and electrically insulating compound about at least the transformer winding assemblies.

19. A method according to claim 18 including forming a mould for the compound about the winding assemblies.

20. A method according to claim 19, wherein the step of forming a mould for the compound comprises locating walls of the mould in engagement with formations formed in the base.

21. A method according to claim 18, including degassing the compound prior to it setting.
